(19) United States
(12) Patent Application Publication
(10) Pub. No.: US 2026/0050561 A1
(43) Pub. Date: Feb. 19, 2026

(54) Method and System for Optimizing Buffer Reservation and Utilization

(71) Applicant: Imagination Technologies Limited, Kings Langley (GB)

(72) Inventor: Ross Torkington, Hertfordshire (GB)

(21) Appl. No.: 19/256,696

(22) Filed: Jul. 1, 2025

(30) Foreign Application Priority Data
Jul. 1, 2024 (GB) 2409491.4

(51) Int. Cl. G06F 13/16; G06F 13/18

(52) U.S. Cl. CPC G06F 13/1673; G06F 13/18

(57) ABSTRACT

A system for controlling memory buffer reservation comprising a transmitter, a receiver and buffer control logic is provided. The transmitter is configured to transmit a plurality of memory requests on two or more request channels, the plurality of memory requests comprising at least one priority request transmitted on a first request channel. The receiver comprises a plurality of buffers, each buffer having an associated credit, wherein each request channel is provided with a credit value based on the number of buffers allocated to receive memory requests from the corresponding request channel, where at least one credit is provided to the first request channel. The buffer control logic enables the first request channel to use a buffer allocated to a second request channel by utilizing a credit provided to the second request channel for transmitting the priority request to the receiver when a credit provided to first request channel is unavailable.

### CROSS-REFERENCE TO RELATED APPLICATIONS AND CLAIM OF PRIORITY

This application claims foreign priority under 35 U.S.C. 119 from United Kingdom patent application No. GB2409491.4 filed on 1^{st} July 2024, the contents of which are incorporated by reference herein in their entirety.

### TECHNICAL FIELD

This application relates to optimizing buffer utilization in a shared memory system.

### BACKGROUND

Modern computing systems are expected to be able to handle a variety of tasks, and often comprise multiple processors, such as a central processing unit (CPU) or a multi-core CPU and/or a graphics processing unit (GPU). Each of the processors may be suited to handle different processing tasks but may operate on the same data stored at a main memory. For instance, the result of a processing task from one processor might be used in the other processor. For example, in a computing system such as a multicore CPU using a shared memory system, each CPU core may act as transmitter of requests and a memory system may act as a receiver of these requests for data/information payloads. Examples of requests include a read request, write request, cache maintenance operations, and virtual memory management operations or more generally any packet of information that one component in a communication network wants to send to one or more other components in the communication network. The receiver receives the request and may read or write the data to a buffer among a pool of buffers in the receiver.

Consider a transmitter transmitting different types of requests. Among the types of requests, one type of request may be a “priority request”, which means that if that request doesn't progress then there can be a deadlock. For example, consider a scenario where a CPU core sends a read request and a write request to a memory system and receives a snoop request from the memory system. In this case, the completion of the read request might be blocked until the snoop request completes and completion of the snoop request might be blocked until the write request completes. Therefore, in this case the write request is considered a priority request and it is vital that the write request can make forward progress to avoid a deadlock.

In order to transmit the data/payloads (requests) between the transmitter and receiver, there needs to be a way to control the transmission between these modules so as ensure that buffers do not overflow, and/or deadlock does not happen. There are various processes/methods to control the transmission between these modules, such as valid-ready handshake and credit-based systems. However, such systems have their own drawbacks, outlined explained hereinafter.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A system for controlling memory buffer reservation comprising a transmitter, a receiver and buffer control logic is provided. The transmitter is configured to transmit a plurality of memory requests on two or more request channels, the plurality of memory requests comprising at least one priority request transmitted on a first request channel. The receiver comprises a plurality of buffers, each buffer having an associated credit, wherein each request channel is provided with a credit value based on the number of buffers allocated to receive memory requests from the corresponding request channel, where at least one credit is provided to the first request channel. The buffer control logic is configured to enable the first request channel to use a buffer allocated to a second request channel by utilizing a credit provided to the second request channel for transmitting the priority request to the receiver when a credit provided to first request channel is unavailable.

According to a first aspect, there is provided a system for controlling memory buffer reservation, the system comprising: a transmitter configured to transmit a plurality of memory requests on two or more request channels, the plurality of memory requests comprising at least one priority request transmitted on a first request channel; a receiver comprising a plurality of buffers, each buffer having an associated credit, wherein each request channel is provided with a credit value based on the number of buffers allocated to receive memory requests from the corresponding request channel, where at least one credit is provided to the first request channel; and buffer control logic configured to enable the first request channel to use a buffer allocated to a second request channel by utilizing a credit provided to the second request channel for transmitting the priority request to the receiver when a credit provided to first request channel is unavailable.

The buffer control logic is further configured to check if there is a credit available to the first request channel, and if not, commandeer the second request channel and use a credit for the second request channel to send the priority request on the second request channel instead.

The buffer control logic is further configured to, on sending the priority request on the second request channel, utilize the buffer allocated to the second request channel for storing the priority request transmitted on the second request channel.

The buffer control logic is further configured to check if there is a credit available to the first request channel and, if not, transfer a credit provided to the second request channel to the first request channel and send the priority request on the first request channel using that credit.

The buffer control logic is further configured to, on transferring a credit provided to the second request channel to the first request channel, utilize the buffer allocated to the second request channel for storing the request transmitted on the first request channel.

The buffer control logic is configured to check if there is a credit available to the first request channel and, if so, send the priority request on the first request channel to a buffer allocated to the first request channel.

The transmitter comprises a plurality of transmitter credit counters each associated with a request channel indicating the number of credits available to a particular request channel for transmitting the memory request.

The receiver comprises a plurality of receiver credit counters each associated with a request channel indicating the number of buffers in the receivers used up by the particular request channel.

The buffer control logic is a standalone module between the transmitter and the receiver.

The buffer control logic is a module within the receiver.

The system is bidirectional with the transmitter and the receiver capable of transmitting and receiving the memory request to each other.

The system further comprises one or more transport nodes between the transmitter and receiver.

Each transport node comprises a transmitter credit counter, a receiver credit counter and at least on request buffer associated with each request channel.

The buffer control logic is a module within the last transport node before the receiver.

According to a second aspect, there is provided a method of controlling memory buffer reservation, where a plurality of memory requests are transmitted from a transmitter to a plurality of buffers in a receiver on two or more request channels, the method comprises: providing a credit value to each request channel among the two or more request channels based on the number of buffers allocated to receive memory requests from the corresponding request channel, wherein at least one credit is provided to a first request channel transmitting at least one priority request among the plurality of memory requests; when transmitting a priority request on the first request channel: identifying if there is a credit available to the first request channel; and enabling the first request channel to utilise a credit provided to a second request channel to transmit the priority request to the receiver when a credit provided to first request channel is unavailable.

When the credit allocated to the first request channel is unavailable, the method comprises commandeering the second request channel and using a credit provided to the second request channel to send the priority request on the second request channel instead of the first request channel.

Commandeering the second request channel to send the priority request on the second request channel to the receiver enables the first request channel to use a buffer allocated to the second request channel.

When the credit allocated to first request channel is unavailable, the method comprises transferring a credit provided to the second request channel to the first request channel and sending the priority request on the first request channel using the transferred credit.

Transferring the credit provided to the second request channel to the first request channel enables the first request channel to use a buffer allocated to the second request channel.

On identifying that there is a credit available to the first request channel, the priority request on the first request channel is sent to a buffer allocated to the first request channel.

According to a third aspect, there is provided a computer readable code configured to cause the method of any of the second aspect to be performed when the code is run.

According to a fourth aspect, there is provided a computer readable storage medium having encoded thereon the computer readable code of the third aspect.

According to a fifth aspect, there is provided an integrated circuit definition dataset that, when processed in an integrated circuit manufacturing system, configures the integrated circuit manufacturing system to manufacture a system according to the first aspect.

According to a sixth aspect, there is provided a non-transitory computer readable storage medium having stored thereon a computer readable description of a system as according to first aspect that, when processed in an integrated circuit manufacturing system, causes the integrated circuit manufacturing system to manufacture an integrated circuit embodying the system.

According to a seventh aspect, there is provided a CPU configured to perform the method of the second aspect.

The system for controlling memory buffer reservation may be embodied in hardware on an integrated circuit. There may be provided a method of manufacturing, at an integrated circuit manufacturing system, a system for controlling memory buffer reservation. There may be provided an integrated circuit definition dataset that, when processed in an integrated circuit manufacturing system, configures the system to manufacture a system for controlling memory buffer reservation. There may be provided a non-transitory computer readable storage medium having stored thereon a computer readable description of a system for controlling memory buffer reservation that, when processed in an integrated circuit manufacturing system, causes the integrated circuit manufacturing system to manufacture an integrated circuit embodying a system for controlling memory buffer reservation.

There may be provided an integrated circuit manufacturing system comprising: a non-transitory computer readable storage medium having stored thereon a computer readable description of the system for controlling memory buffer reservation; a layout processing system configured to process the computer readable description so as to generate a circuit layout description of an integrated circuit embodying the system for controlling memory buffer reservation; and an integrated circuit generation system configured to manufacture the system for controlling memory buffer reservation according to the circuit layout description.

There may be provided computer program code for performing any of the methods described herein. There may be provided non-transitory computer readable storage medium having stored thereon computer readable instructions that, when executed at a computer system, cause the computer system to perform any of the methods described herein.

The above features may be combined as appropriate, as would be apparent to a skilled person, and may be combined with any of the aspects of the examples described herein.

### BRIEF DESCRIPTION OF THE DRAWINGS

Examples will now be described in detail with reference to the accompanying drawings in which:

FIG. 1A illustrates a computing system;

FIG. 1B illustrates a system transmitting payload between a transmitter and a receiver;

FIG. 2 illustrates another system transmitting payload between a transmitter and a receiver;

FIG. 3 illustrates yet another system transmitting payload between a transmitter and a receiver;

FIG. 4 illustrates a system 400 for controlling the buffer utilization when transmitting payload between a transmitter and a receiver;

FIG. 5A illustrates a first embodiment of the system 400;

FIG. 5B illustrates a second embodiment of the system 400;

FIG. 6 illustrates a method of transmitting payload between a transmitter and a receiver;

FIG. 7 illustrates a computer system in which a buffer control system is implemented; and

FIG. 8 illustrates an integrated circuit manufacturing system for generating an integrated circuit embodying a buffer control system.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is presented by way of example to enable a person skilled in the art to make and use the invention. The present invention is not limited to the embodiments described herein and various modifications to the disclosed embodiments will be apparent to those skilled in the art.

Embodiments will now be described by way of example only.

As mentioned earlier, in order to transmit the data/payloads (requests) between the transmitter and receiver in a computing system, there needs to be way to control the transmission between these modules so as ensure that buffers do not overflow, and/or deadlock does not happen. Various methods and systems to control the transmission between these modules are described below. In the following description, a transmitter may also be referred to as a requestor or producer, and a receiver may also be referred to as a requestee or consumer.

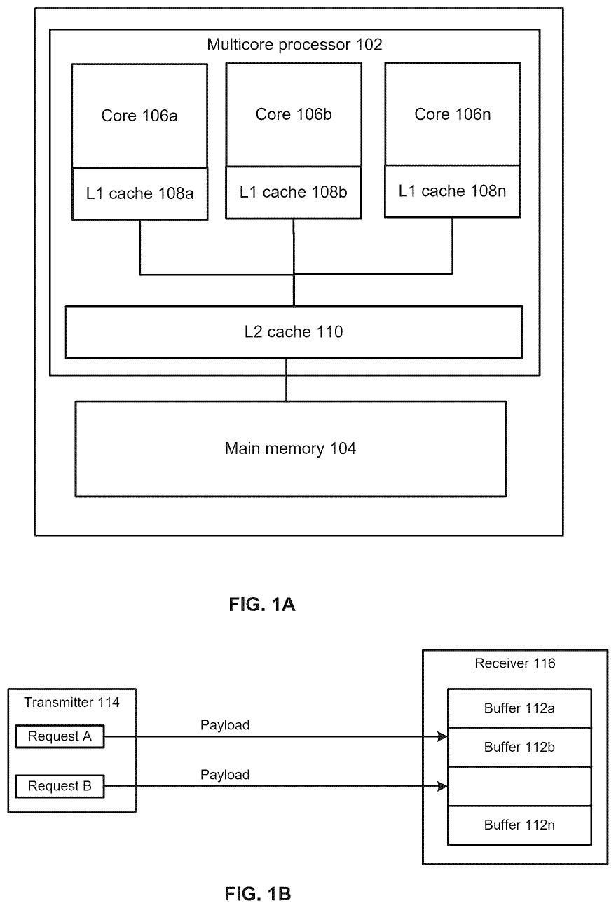

FIG. 1A shows an example computing system according to the present invention. The computing system 100 in this example is a muti-core system. The system 100 comprises a multicore processor 102 and a memory 104. The multicore processor 102 comprises a plurality of cores 106a, 106b . . . 106n and a plurality of L1 caches 108a, 108b . . . 108n. Each core is an independent processing unit capable of reading and executing program instructions. The plurality of cores can interact with each other and hence benefit from the advantage of parallel processing and resource sharing. Each core has an L1 cache for storing instructions and data for that core.

The multicore processor 102 further comprises an L2 cache 110. L2 cache 110 is shared among the plurality of cores to store instructions and data. The L2 cache plays a role in maintaining cache coherency among different cores in a multi-core processor, ensuring that all cores have a consistent view of shared memory. By reducing the time it takes to fetch data from main memory 104, the L2 cache contributes to overall system performance. In the embodiments explained below, a core among the plurality of cores can act as a transmitter and the L2 cache can act as a receiver.

Another example system could be a computer interacting with peripheral devices such as a printer, touch screen, keyboard, or a mouse. The computer would be a transmitter and the printer would act as a receiver. The data buffer inside the printer act as the plurality of buffers in the receiver. In another example ‘interrupt’ requests produced by computer peripherals such a touch screen, a keyboard, and a mouse that get sent to and consumed by a CPU. The CPU might have certain resources for servicing interrupt requests and might reserve some of them for high priority interrupt requests that need to be serviced without relying on a lower priority interrupt request making progress. In this example the peripheral devices would act as a transmitter and the computer would act as a receiver.

FIG. 1B illustrates a simple system transmitting data/payloads between a transmitter and a receiver. The system comprises a transmitter 114 and a receiver 116. The transmitter 114 transmits payloads by sending a plurality of types of requests (Request A, Request B) via different request channels. The different types of requests include, but are not limited to, read requests, write requests, cache maintenance operations, and virtual memory management operations etc. Consider that request A is a read request transmitted across a first request channel and a request B is a write request transmitted across a second request channel. The system comprises a plurality of buffers 112a, 112b . . . 112n in receiver 116 configured to store the incoming payloads. Consider that the request B is a priority request and therefore it is vital that the request B (write request) can make forward progress to avoid a deadlock. A simple implementation to ensure that the write request makes progress is to allocate one buffer dedicated for the second request channel transmitting request B. However, in this case, if there are a stream of request B transmitted on the second request channel, only the first request B could make progress and the remaining requests would have to wait until the dedicated buffer is freed. This system can be very inefficient if there are a large number of incoming requests Bs. Hence there is a need for a better way of controlling the transmission between a transmitter and a receiver.

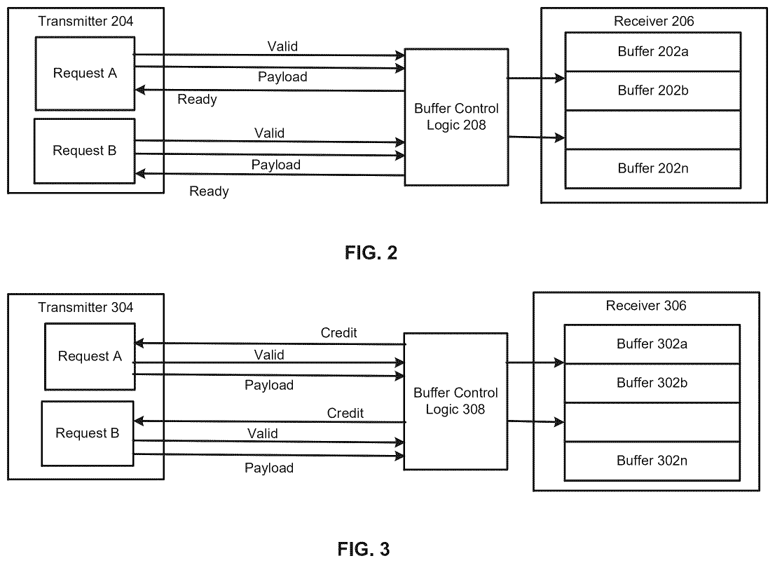

FIG. 2 illustrates another example system for controlling the transmission of data/payloads between a transmitter and a receiver using a valid ready handshake. The system comprises a transmitter 204, receiver 206 and buffer control logic 208. The transmitter 204 transmits payloads to the receiver by sending a plurality of types of requests (Request A, Request B) via different request channels. Consider that Request A is a read request transmitted across a first request channel and Request B is a write request transmitted across a second request channel. The system comprises a plurality of buffers 202a, 202b . . . 202n in the receiver 206 configured to store the incoming payloads. The transmission of data between the transmitter and the receiver can be controlled using a valid ready handshake.

Valid ready handshakes are a flexible way of connecting and controlling these transmitter and receiver modules to transfer data/payloads. Both modules have three signals valid, ready and data. The transmitter outputs valid and data signals and takes ready as input. The receiver outputs the ready signal and receives valid and data signals. The transmitter may at any time set a valid signal to 1/high when data is available, and the consumer sets ready signal to 1/high only when it can accept data. When a request A or B is sent by the transmitter 104, the transmitter sets a valid signal corresponding to the particular request channel to 1/high. When the receiver 106 has a buffer available ready to receive the payload the receiver sets ready signal to 1/high. When both valid and ready signals are high, the handshake is complete, the receiver accepts the data in the same cycle, and the ready and valid signals are set to 0 if necessary. After a handshake completes, the transmitter sets the valid signal to 0 if it has no more data, otherwise it keeps valid signal set to high for the next handshake. Similarly, the receiver sets the ready signal to 0 if it cannot accept more data, otherwise it keeps ready signal high and complete the next handshake in if valid is also high.

The buffer control logic 208 monitors the valid signal from the request channels continuously and provides a ready signal back to indicate acceptance of a payload. Consider request B is a priority request and therefore it is vital that the request B can make forward progress to avoid a deadlock. In such cases, the buffer control logic 208 on observing a valid signal from both Request A and B checks if there is a buffer available in the receiver for receiving the payload and if so checks if accepting a payload from Request A via the first request channel will not result in all buffers being occupied by payload from Request A. The buffer control logic 208 enables receiving a payload from Request A only if at least one buffer is left available for Request B unless Request B is already using a buffer among the plurality of buffers. In other words, if receiving a payload from Request A uses up all the buffers without leaving any buffer for Request B, then the buffer control logic 208 will not provide a ready signal back for Request A unless another buffer is freed. If there is only one buffer allocated to Request B and if Request B is already using that buffer, then the buffer control logic 208 will not provide a ready signal back for Request B unless that buffer allocated to Request B is freed. The buffer control logic provides the ready signal to both Request A and B if at least one buffer is available for Request B. With valid ready handshakes, the transmission between the transmitter and the receiver is controlled in the same cycle that the transmission is made. However, there is computation involved within the cycle for providing valid and ready signals on time.

FIG. 3 illustrates another system for transmitting data/payloads between a transmitter and a receiver using a credit-based systems. The system comprises a transmitter 304, receiver 306 and a buffer control logic 308. The transmitter 304 transmits payloads from the receiver by sending a plurality of types of requests (Request A, Request B) via different request channels. Consider that request A is a read request transmitted across a first request channel and a request B is a write request transmitted across a second request channel. The system comprises a plurality of buffers 302a, 302b . . . 302n in the receiver 306 configured to store the incoming payloads, each buffer having an associated credit. The system also comprises buffer control logic 308 which controls the transmission between the transmitter and the receiver. The buffer control logic 308 allocates each buffer to a request channel and provides credits to each request channel indicating the number of buffers allocated to each channel. The credits for each request channel are provided to the transmitter at least one cycle ahead of the transmission. The transmission of a payload between the transmitter and receiver occurs only if the corresponding request channel has an available credit, in which case the buffer control logic is guaranteed to accept the payload immediately.

When a Request A and/or B is sent by the transmitter 304, the corresponding request channel sets a valid signal to 1 indicating that a payload is being transmitted. The transmitter transmits the payload if a credit is already provided for the corresponding request channel. Once the payload is transmitted, the transmitter decrements one credit provided to the request channel indicating that one buffer is used up. Consider request B (write request) is a priority request and therefore it is vital that the request B can always make forward progress to avoid a deadlock. In such cases, buffer control logic ensures that there are at least one buffers already allocated to the request channel transmitting the priority request to ensure that the priority request always makes progress. In a simple example implementation, to ensure that the request B makes progress, the buffer control logic allocates equal credits to each request channel. Suppose there are four buffers and two request channels, the buffer control logic would allocate two credits each to both request channels. This would ensure that the request B would progress and that all the buffers would not be used up by request A. However, if there is a stream of request A coming and there are only a few request Bs, then the utilization of the buffer would be very inefficient as the credits for the buffers are pre-allocated by the buffer control logic.

The inventors have devised a more efficient method of controlling the utilization of the buffers using the credit-based system. The inventors have devised a method of providing a request channel transmitting priority requests to dynamically use the credits provided to the other request channels to ensure that the priority request makes progress always while also ensuring that the buffer reservation and utilization is optimised. The method comprises allocating at least one buffer to the request channel transmitting a priority request, and allocating the remaining buffers to the other request channels. Further, when the request channel transmitting and sending a priority request has already utilized all the allocated buffer, the buffer control logic is configured to commandeer the buffers allocated to the other request channels to thereby allow subsequent priority requests to progress without waiting for the dedicated buffers to become available.

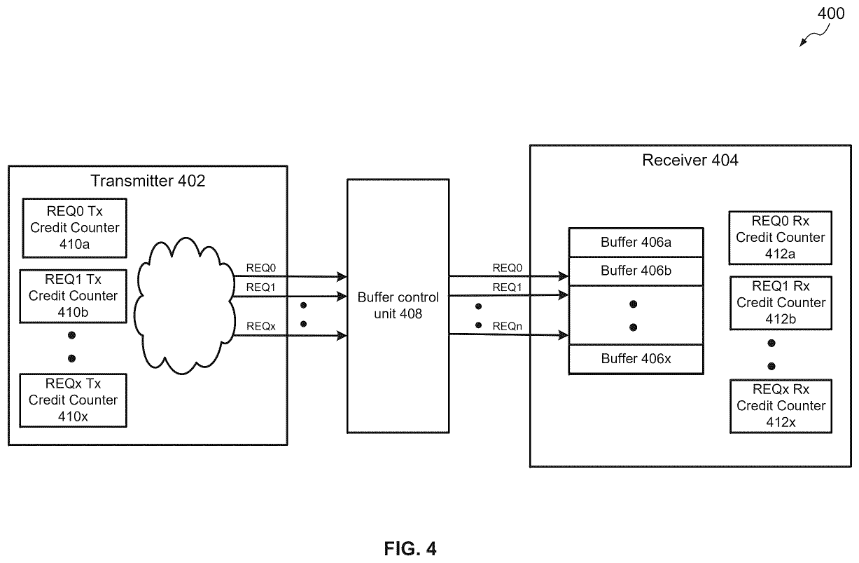

FIG. 4 illustrates an example system 400 for transmitting data/payloads between a transmitter and a receiver using a credit-based system. The system 400 in FIG. 4A comprises a transmitter 402, a receiver 404 and buffer control logic 408. In one example, the transmitter could be a CPU core as explained in FIG. 1A and the receiver could be a memory system (such as an L2 memory system) communicating with the CPU core. The receiver further comprises a plurality of buffers 406a, 406b . . . 406n each having a credit. The transmitter 402 comprises two or more request channels REQ0, REQ1 . . . . REQx transmitting a plurality of types of memory requests. The various types of memory requests may include, but are not limited to: a read request, a write request, a cache maintenance request etc. In one example embodiment, each request channel transmits and receives a particular type of request such as REQ0 channel transmitting and receiving read requests, and the REQ1 channel transmitting and receiving only write requests. In another embodiment, there may be more than one channel transmitting and receiving same types of requests such as REQ0 and REQ1 channel transmitting and receiving read requests, and the REQ2 and REQx channels transmitting and receiving write requests. In yet another embodiment, a request channel may receive more than one type of request, such as the REQ0 channel transmitting and receiving both read requests and cache maintenance requests, whilst the REQ1 channel may transmit and receive only write requests. One or more types of requests may be considered as a priority request, where the priority requests are allowed to progress to avoid any stalls. Thus, it is essential as described earlier to ensure that the priority request make progress.

The transmitter 402 comprises a plurality of transmitter (Tx) credit counters 410a, 410b . . . 410x where each Tx credit counter is associated with a corresponding request channel REQ0, REQ1 . . . . REQx. Similarly, the receiver 404 comprises a plurality of receiver (Rx) credit counters 412a, 412b . . . 412x where each Rx credit counter is associated with a corresponding request channel REQ0, REQ1 . . . . REQx. Each buffer among the plurality of buffers 406 is reserved for use by a request channel. Each request channel is provided with credits corresponding to the number of buffers allocated to the request channel. The request channel transmitting a priority request is allocated at least one buffer, such that there is always one buffer free to be used or is being used by that request channel. At reset, all the allocated credits will be with the receiver and each Rx credit counter will indicate the number of buffers allocated to each request channel. After reset, the credits are transmitted to the transmitter and the Tx credit counters will indicate the number of credits and therefore the number of buffers allocated to each request channel. The transmitter may then transmit a request with an associated payload through a request channel if the particular request channel has a credit available to it.

The system 400 further optionally comprises one or more transport nodes (not shown in FIG. 4) between the transmitter and receiver for storing and transmitting payloads when the transmitter and receiver are located far apart from each other. However, when the transmitter and receiver are close to each other, there is no requirement to use transport nodes. The transport nodes form part of a mesh network i.e., an interconnect internal to the CPU. Each transport node comprises a transmitter (Tx) credit counter associated with each request channel and a receiver (Rx) credit counter associated with each request channel. Further each transport node comprises at least one buffer corresponding to each request channel. The data/payload received at the transport node via a particular request channel is stored in the buffer allocated to the request channel until the payload is further transmitted to a next transport node or the receiver.

The buffer control logic 408 controls the buffer utilisation and reservation in the system 400. The buffer control logic 408 controls the transmitting and receiving of the data/payload on a request channel. The buffer control logic 408 may be a module inside the receiver 404 or inside the last transport node or even may be a stand-alone unit between the last transport node and receiver. The buffer control logic enables the transmitting and receiving of the data/payload on a request channel if there is a credit available to the particular request channel i.e. if the corresponding Tx credit counter has a credit available. The Tx credit counters will always increment when a credit is provided by the transport node next to the transmitter or by the receiver (if there aren't any transport nodes between the transmitter and the receiver). Once the transmitter sends a payload, the transmitter decrements one credit in the corresponding Tx credit counter indicating that the request is transmitted. The receiver, on receiving the data/payload in the buffer allocated to the request channel, increments the corresponding Rx credit counter indicating that the buffer is in use. If no credits are available for a particular request channel, then the buffer control logic waits until a buffer allocated to the particular request channel is freed. When a buffer is freed up, the receiver can send a credit to the transmitter (i.e. the Tx credit counter is incremented) and the receiver decrements a credit in the Rx credit counter. The transmitter (Tx) credit counters and a receiver (Rx) credit counters in the transport node increments and decrements in a similar way.

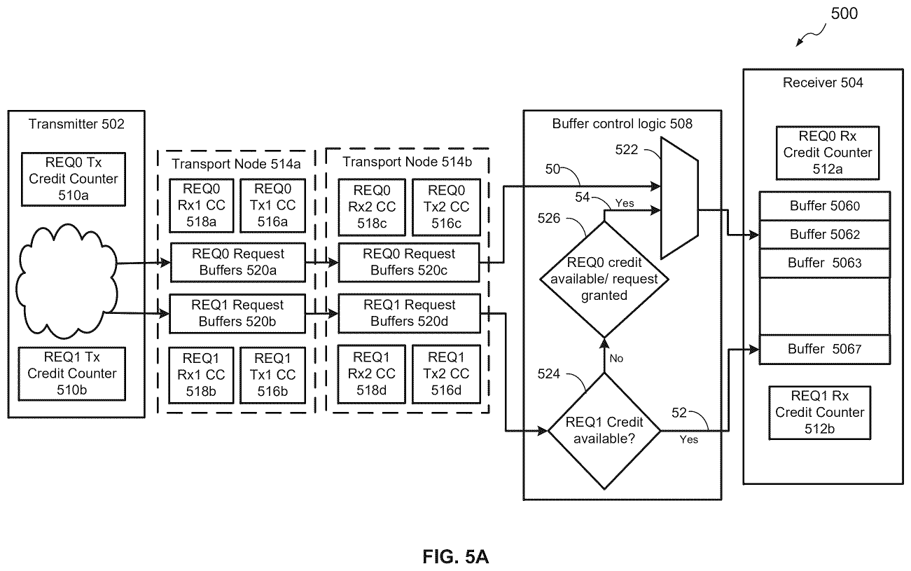

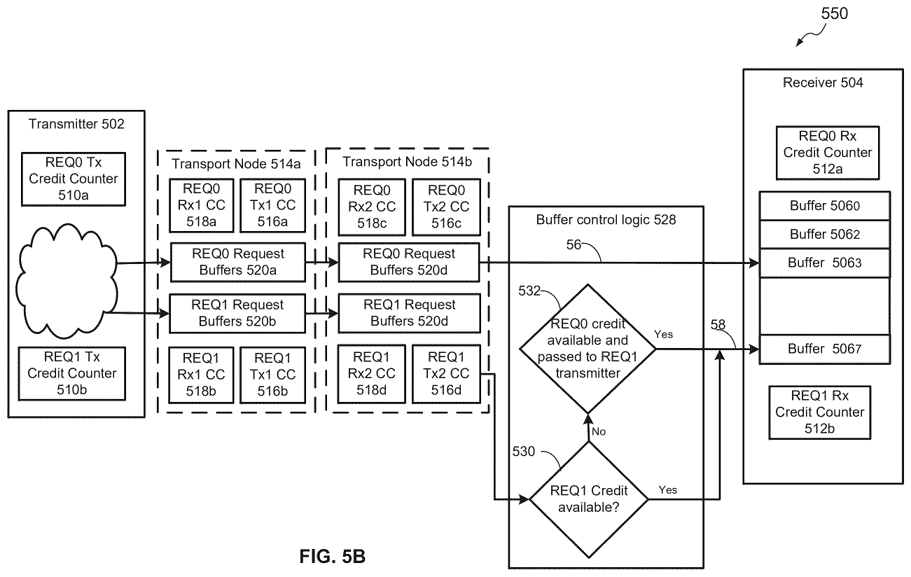

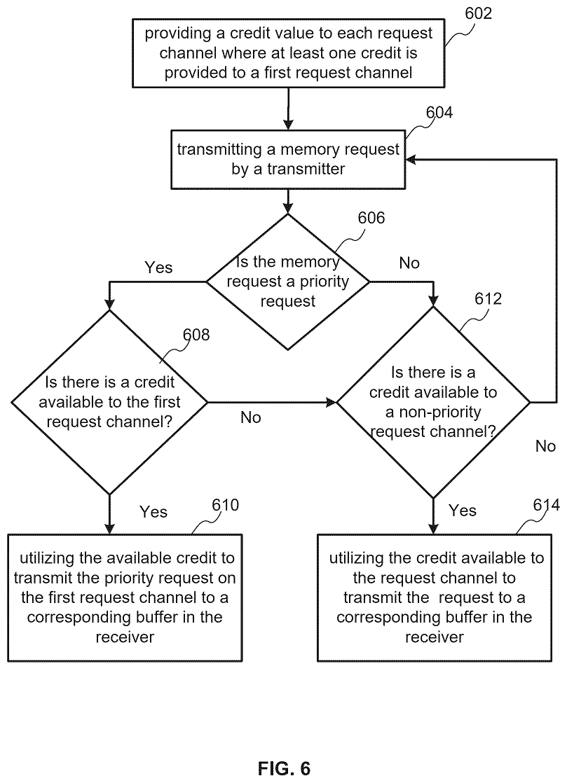

Consider a scenario in which the transmitter is transmitting a priority request over a request channel REQi. The buffer control logic checks if there is any credit allocated with the request channel REQi. If there is a credit available and hence an allocated buffer, the buffer control logic enables the transmission of the priority request over REQi channel. If no credit is available for REQi channel i.e. the credit/buffer allocated to REQi channel is already used up, then the buffer control logic controls the buffer utilisation by commandeering another request channel REQj and transmitting the payload to the buffer allocated to request channel REQj, thereby allowing the priority request to keep progressing. The mechanism of how the buffer utilization is controlled in this way is explained in detail below with respect to FIGS. 5A, 5B and 6.

FIG. 5A illustrates a first embodiment of the system 400 in accordance with the present invention. The system 500 comprises a transmitter 502, a receiver 504 and a buffer control logic 508. The receiver 504 further comprises a plurality of buffers. The transmitter 502 comprises two or more request channels transmitting a plurality of types of requests. In this example embodiment, consider there are eight buffers 506₀, 506₁, 506₂ . . . 506₇, each buffer having an associated credit, and two request channels REQ0 and REQ1. Each request channel will be allocated with credits corresponding to the number of buffers allocated to that request channel.

In this example, consider that the REQ0 channel transmits and receives read requests and the REQ1 channel transmits and receives write requests which are priority requests. It is essential as described earlier to ensure that the priority requests make progress. Consider seven buffers 506₀, 506₁ . . . 506₆ among the eight buffers are allocated to the request channel REQ0 and one buffer 506₇ is allocated to the REQ1 channel. In other words, 7 buffers are reserved to be used by the REQ0 channel and 1 buffer is reserved to be used by the REQ1 channel. Hence seven credits are provided to REQ0 channel and 1 credit is provided to the REQ1 channel.

The transmitter 502 further comprises a REQ0 Tx credit counter 510a associated with the REQ0 channel, and a REQ1 Tx credit counter 510b associated with the REQ1 channel. Similarly, the receiver 504 comprises a REQ0 Rx credit counter 512a associated with the REQ0 channel, and a REQ1 Rx credit counter 512b associated with the REQ1 channel. At reset, all the allocated credits will be with the receiver and each Rx credit counter will indicate the number of credits provided to each request channel. After reset, the credits are transmitted to the transmitter and the Tx credit counters will indicate the number of credits and therefore the number of buffers allocated to each request channel.

The system 500 in FIG. 5 depicts two transport nodes, transport node 514a and transport node 514b. The transport node 514a comprises REQ0 Tx1 credit counter 516a associated with REQ0 channel, and a REQ1 Tx1 credit counter 516b associated with REQ1 channel. The transport node 514a further comprises a REQ0 Rx1 credit counter 518a associated with REQ0 channel and a REQ1 Rx1 credit counter 518b associated with REQ1 channel. Also, the transport node 514a comprises REQ0 Request Buffers 520a and REQ1 Request Buffers 520b. There can be one or more request buffers corresponding to each request channel in each transport node. Similarly, the transport node 514b comprises REQ0 Tx2 credit counter 516c associated with REQ0 channel, and a REQ1 Tx2 credit counter 516d associated with REQ1 channel. The transport node 514b further comprises a REQ0 Rx2 credit counter 518c associated with REQ0 channel and a REQ1 Rx2 credit counter 518d associated with REQ1 channel. Also, the transport node 514a comprises REQ0 Request Buffers 520c and REQ1 Request Buffers 520d. There can be none, one or any number of transport nodes between the transmitter and the receiver.

The buffer control logic 508 comprises a mux 522. When a read request is transmitted on REQ0 channel, the transmitter checks if the REQ0 Tx credit counter 510a has a credit available. The system asserts the valid and payload signals and transmits the read request to the first transport node 514a where the request is stored in REQ0 request buffer 520a. The system also decrements its REQ0 Tx credit counter when the request is sent out. The first transport node transmits the read request to the second transport node if the REQ0 Tx1 credit counter 516a has a credit available. The read request is transmitted to the second transport node 514b where the request is stored in REQ0 request buffer 520c. Similarly, the second transport node 514b (the last transport node or the transmitter if there are no transport nodes), transmits the read request to the receiver if the REQ0 Tx2 credit counter 516c has a credit available. The buffer control logic 508 checks if there is a credit available and hence if there is a buffer associated with REQ0 channel ready to accept the request. If there is an available credit, the mux 522 sends the read request to the corresponding buffer on path 50.

If there are a number of transport nodes, the read request is similarly transmitted across all the transport nodes. If there are no transport nodes between the transmitter and the receiver, then the read request is transmitted directly from the transmitter to the receiver. When a series of read requests are transmitted on the REQ0 channel, the read requests are transmitted to the receiver until all the 7 credits allocated to the REQ0 channel are used up. Once all 7 credits are utilized, then the transmitter would wait until a buffer associated with REQ0 channel is freed and the REQ0 channel gets a new credit.

When a priority request (write request) is transmitted by the transmitter on REQ1 channel, the transmitter checks if the REQ1 Tx credit counter 510b has a credit available. The write request is then transmitted to the first transport node 514a where the request is stored in the REQ1 request buffer 520b. The first transport node transmits the write request to the second transport node 514b if the REQ1 Tx1 credit counter 516b has a credit available. The write request is transmitted to the second transport node 514b where the request is stored in the REQ1 request buffer 520d. Similarly, the second transport node 514b (the last transport node or the transmitter if there are no transport nodes), transmits the write request to the receiver if the REQ1 Tx2 credit counter 516d has a credit available. The buffer control logic 508 checks if REQ1 Tx2 credit counter 516d has a credit available and hence a buffer associated with REQ1 channel ready to accept the request. If ‘Yes’, the mux 522 sends the write request to the buffer allocated to the REQ1 channel on path 52.

When a second write request is transmitted on the REQ1 channel, buffer control logic 508 checks if the REQ1 channel has a credit available, i.e. if the REQ1 Tx2 credit counter 516d has a credit available 524. If ‘No’ then the buffer control logic checks at 526 if the REQ0 channel has a credit available i.e. if a credit is available for the REQ0 Tx2 credit counter 516c. If ‘Yes’, then the buffer control logic 508 enables the REQ1 transmitter to request the use of the REQ0 channel, thus commandeering the REQ0 channel. The mux 522 then sends the write request on the REQ0 channel instead of REQ1 channel on path 54 utilizing a credit from REQ0 Tx2 credit counter 516c and stores the request in the buffer associated with the REQ0 channel. The buffer control logic 508 also notifies the transmitter and receiver that the corresponding buffer associated with the REQ0 channel is used up by the REQ1 channel. Thus, when there is a stream of write requests (request B), the write request on the REQ1 channel starts using up the buffer that is reserved for the REQ1 channel and then uses the other buffers reserved for the REQ0 channel by virtue of hopping on the REQ0 channel. If we have a request stream of request A (reads) coming up on the REQ0 channel they can use all the buffers allocated to the REQ0 channel except the one that has been reserved for the REQ1 channel.

The buffer control logic 508 may be implemented as a module within the transport node (here transport node 514b) or within the receiver (if there are no transport nodes) or as a stand-alone module between the last transport node (or transmitter if there are no transport nodes) and receiver. When the buffer control logic 508 is not within the receiver the channel hopping happens fully contained in the transport node network (such as the mesh network in multicore CPU example) and the receiver does not need to know/care when the hopping occurs. The receiver receives the signals as it receives normally, and the transmitter transmits the signal as it does normally. In other words, signals at the output of the transmitter and input of the receiver are identical thereby making it easier to implement the transport node network (or a mesh network) in a scalable/configurable way that allows it to connect to a variety of components.

The transmission of a request from transmitter to the receiver can be explained in more detail with reference to the tables provided below. At reset, all credits are with the receiver as shown in Table 1. In this example, the receiver has 8 buffers, 506₀-506₇. Therefore, as explained earlier REQ0 Rx credit counter 512a is allocated with 7 credits associated with requests arriving on the REQ0 channel, and a REQ1 Rx credit counter 512b is allocated with 1 credit associated with requests arriving on the REQ1 channel. Thus, one request buffer in the receiver is reserved for requests arriving on REQ1 channel, and 7 are nominally assigned to requests arriving on REQ0 channel. Further the Rx1 and Rx2 credit counters for the REQ0 and REQ1 channels are provided as 2 indicating that each transport node has 2 buffers for each channel:

TABLE 1

| | Modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 0 | 2 | 0 | 2 | 0 | 7 |
| REQ1 | 0 | 2 | 0 | 2 | 0 | 1 |

After reset, the credits are passed from the receiver credit counters to the transmitter credit counters as shown in Table 2. Thus, the credit from the receiver is provided to the last transport node and the one from the last transport node is provided to the previous one and so on:

TABLE 2

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 7 | 0 |
| REQ1 | 2 | 0 | 2 | 0 | 1 | 0 |

Now consider that the transmitter sends a priority request on the REQ1 channel. The credit-based system asserts the valid and payload signals and decrements its REQ1 Tx credit counter as shown in Table 3. Also, the transport node 514a receives the payload and increments its REQ1 Rx1 credit counter.

TABLE 3

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 7 | 0 |
| REQ1 | 1 | 1 | 2 | 0 | 1 | 0 |

Transport 514a then uses one of its REQ1 Tx1 credits to send the write request to Transport node 514b. Transport node 514b increments its REQ1 Rx2 credit counter when it receives the payload as shown in Table 4. Also, the transport node 514a is now holding a REQ1 Rx1 credit but since it has passed the write request to the transport node 514b, the REQ1 request buffer is freed, so it can pass the REQ1 Rx1 credit back to the REQ1 Tx credit counter in the transmitter for it to use again in future:

TABLE 4

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 7 | 0 |
| REQ1 | 2 | 0 | 1 | 1 | 1 | 0 |

Transport node 514b now uses its REQ1 Tx2 credit to send the write request to the receiver. The receiver increments its REQ1 Rx credit counter when it receives the payload and holds onto the credit while the write request is being processed as shown in Table 5. Also, the transport node 514b can now send the REQ1 Rx2 credit back to REQ1 Tx1 credit counter since it has passed the write request to the transport node 514b, the REQ1 request buffer is freed. The REQ1 Tx1 credit counter can use the credit again in future:

TABLE 5

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 7 | 0 |
| REQ1 | 2 | 0 | 2 | 0 | 0 | 1 |

Consider that the transmitter sends a second write request on REQ1. The credit-based system asserts the valid and payload signals and decrements its REQ1 Tx credit counter as shown in Table 6. Transport node 514a receives the payload and increments its REQ1 Rx1 credit counter:

TABLE 6

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 7 | 0 |
| REQ1 | 1 | 1 | 2 | 0 | 0 | 1 |

Transport 514a then uses one of its REQ1 Tx1 credits to send the write request to Transport node 514b as shown in Table 7. Transport node 514b increments its REQ1 Rx2 credit counter when it receives the payload. Also, the transport node 514a decrements the REQ1 Rx1 credit counter since it has passed the write request to the transport node 514b, and the REQ1 request buffer is freed. So the REQ1 Rx1 credit is passed back to the REQ1 Tx credit counter and the transmitter can use it again in future:

TABLE 7

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 7 | 0 |
| REQ1 | 2 | 0 | 1 | 1 | 0 | 1 |

As explained earlier with respect to Table 5, the second write request at the Transport node 514b cannot be transmitted to the receiver because the receiver is holding on to the credit while the first write request is being processed. In other words, the transport node 514b, the REQ1 Tx2 credit counter needs the one credit allocated to REQ1 channel to be provided back to the REQ1 Tx2 credit counter before it can send anything else to the receiver.

In this situation the buffer control logic 508 enables the write request to hop on to the REQ0 channel and utilize a credit allocated to the REQ0 channel to ensure that the priority request keeps making progress. The buffer control logic 508 in FIG. 5A can also be known as channel hopper logic. The buffer control logic 508 checks if the REQ0 Tx2 credit counter on the transport node 514b has credits available for sending the request on REQ0 channel. In this case, the REQ0 Tx2 credit counter has 7 credits available for sending requests on REQ0. The buffer control unit requests for a credit from the REQ0 Tx2 credit counter to send the second write request. The transport node 514b decrements REQ0 Tx2 credit counter since it uses the credit for REQ0 channel to send the second write request to the receiver. Thus, the buffer control logic 508 commandeers the buffer allocated to the REQ0 channel and allow REQ1 channel to send the write request on the REQ0 channel. The receiver on receiving the request increments the REQ0 Rx credit counter indicating that a buffer allocated to REQ0 channel is used up. Also, the transport node 514b decrements REQ1 Rx2 credit counter since it has passed the write request to the receiver, and the REQ1 request buffer is freed. So, the REQ1 Rx2 credit is passed back to REQ1 Tx1 credit counter:

TABLE 8

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 6 | 1 |
| REQ1 | 2 | 0 | 2 | 0 | 0 | 1 |

Thus, the write request is transmitted on the REQ1 channel until the transport node 514b. Since there is no credit available to the REQ1 channel i.e. the buffer allocated to REQ1 channel is used up, the buffer control logic 508 enables the write request to hop from the REQ1 channel to REQ0 channel at the transport node 514b. The write request is transmitted to the receiver from the transport node 514b on the REQ0 channel instead of the REQ1 channel thereby ensuring the progressing of the write request.

If the write request hops on to the REQ0 channel any earlier than at/after the last transport node 514b, there are chances that the write request might get stuck behind a non-priority request and hence might not make a guaranteed progress. Consider that the write request hops to REQ0 channel when the write request is transmitted from the transmitter to the first transport node 514a. In this case if there are read requests already stored in the REQ0 request buffers of the transport node 514b, then the write request must wait until a read request is transmitted from transport node 514b and a REQ0 request buffer is freed. Or in another case if all the buffers allocated to the REQ0 channel are used up, then the write request must wait until the buffers allocated to the REQ0 channel in the receiver is freed and eventually the read request is transmitted from transport node 514b and a REQ0 request buffer is freed. If a dependency exists such that the non-priority requests transmitted on the REQ0 channel cannot be processed, and the request buffers freed, until the priority request is processed then the system can deadlock.

In other words, a request is transmitted on the corresponding request channel across all transport nodes and is stored in the corresponding request buffer in each transport node until it reaches the last transport node. On reaching the last transport node (or transmitter if there are no transport nodes), the buffer control logic sees if the request is a priority request and whether the corresponding buffer allocated to the particular request channel is free or not. Depending on the availably and priority of the request the buffer control logic sends the request to the buffer allocated to the particular request channel or buffers allocated to the other request channels by hopping on to the other request channel. If the priority request hops on to a different request channel any earlier than after the last transport node, the priority request might get stuck behind a non-priority request and hence might not make guaranteed progress.

Now, although the buffer control logic 508 is mux-ing between two requests that want to send data on REQ0 channel, these requests have quite a lot of information with them. So, mux-ing between two requests with large amounts of information does make the buffer control logic complicated. Requesting mux-ing on the REQ0 channel might also affect the area/frequency of a silicon implementation. Also, since a credit for the REQ0 channel is commandeered by a request in the REQ1 channel therefore it needs to be ensured that the counters are correctly updated on the REQ0 channel. Further when the REQ1 buffer at receiver is used up and the write requests are sent via the REQ0 channel, only one request can be transmitted and processed at a time even though there are two request channels. In other words, a request on REQ0 channel cannot be transmitted to the receiver in the same cycle as a priority request on REQ1 channel if the priority request is using the REQ0 channel instead of the REQ1 channel. This would reduce the performance of the system. To address some of these issues an alternative embodiment can be used, as outlined below. Therefore, the inventors devised a different credit transfer mechanism where the credits allocated to other channels can be transferred to the priority request channel if the buffer allocated to the priority request channel is already in use. In this case, even though the buffer allocated to the priority request channel is already used up, the request is sent on the same priority request channel till the payload reaches the receiver using the credits transferred to the priority request channel. This is explained in further detail with respect to FIG. 5B.

FIG. 5B illustrates a second embodiment of the system 400 in accordance with the present invention. FIG. 5B is similar to FIG. 5A except for the buffer control logic 528. In FIG. 5B the buffer control logic 528 works on a credit transfer mechanism rather than using a channel hopping mechanism.

The system 550 comprises a transmitter 502, a receiver 504 and buffer control logic 528. The receiver 504 further comprises a plurality of buffers 506₀, 506₁, 506₂ . . . 506₇ and two request channels REQ0 and REQ1 transmitting read requests and write requests respectively. The system 550 works in exactly in the same manner as system 500 described above with respect to FIG. 5A when transmitting a request from the transmitter until the requests are transmitted to the last transport node 514b.

Consider the same example scenario that the REQ0 channel transmits and receives read request and the REQ1 channel transmits and receives only write request which is a priority request. It is essential as described earlier to ensure that the priority requests make progress. Seven buffers 506₀, 506₁ . . . 506₆ among the eight buffers in the receiver are allocated to the request channel REQ0 and one buffer 506₇ is allocated to the REQ1 channel. Hence 7 credits are provided to the REQ0 channel and 1 credit is provided to the REQ1 channel.

The buffer control logic 528 uses a credit transfer mechanism. When a read request is transmitted on REQ0 channel, the read request is transmitted from the transmitter to the transport node 514a and from transport node 514a to transport node 514b along the REQ0 channel as explained in FIG. 5A. The buffer control logic 528 then checks if there is a credit available at the transmitter credit counter (REQ0 TX2 credit counter 516c) and hence if there is a buffer associated with the REQ0 channel ready to accept the request. If there is an available credit, the buffer control logic 528 sends the read request to the corresponding buffer on path 56. When a series of read requests are transmitted on the REQ0 channel, the read request is transmitted to the receiver until all the 7 credits allocated to the REQ0 channel are used up. Once all 7 credits are utilized, then the transmitter would wait until a buffer associated with the REQ0 channel is freed and the REQ0 channel gets a new credit.

When a priority request (write request) is transmitted by the transmitter on REQ1 channel, the transmitter checks if the REQ1 Tx credit counter 510b has a credit available. The write request is then transmitted to the first transport node 514a where the request is stored in the REQ1 request buffer 520b. The first transport node transmits the write request to the second transport node 514b if the REQ1 Tx1 credit counter 516b has a credit available. The write request is then stored in the REQ1 request buffer 520d. Similarly, the second transport node 514b (the last transport node or the transmitter if there are no transport nodes), transmits the write request to the receiver if the REQ1 Tx2 credit counter 516d has a credit available. The buffer control logic 528 checks if the REQ1 Tx2 credit counter 516d has a credit available (at 530) and hence a buffer associated with REQ1 channel is ready to accept the request. If ‘Yes’, the buffer control logic 528 sends the write request to the buffer allocated to the REQ1 channel on path 58.

In a first implementation, when a second write request is transmitted on the REQ1 channel, buffer control logic checks if the REQ1 channel has a credit available, i.e. if the REQ1 Tx2 credit counter 516d has a credit available. If ‘No’ then the buffer control logic checks if the REQ0 channel has a credit available (at 532) i.e. if a credit is available for the REQ0 Tx2 credit counter 516c. If ‘Yes’, the buffer control logic 530 then requests transfer of one credit to REQ1 channel from any other channel (here the REQ0 channel). If the REQ0 Tx2 credit counter 516c has available credits, one credit among the available credits is provided to the REQ1 channel. The buffer control logic 528 utilizes the credit provided from REQ0 Tx2 credit counter 516c to sends the write request to the receiver on the REQ1 channel (on path 58) in the same clock cycle and stores the request in the buffer allocated to the REQ0 channel from where the credit was transferred to the REQ1 channel. The buffer control logic 528 also sends a signal indicating that the REQ1 channel is utilizing the credit allocated to REQ0 channel to notify the transmitter and receiver that the corresponding buffer associated with the REQ0 channel is used up by the REQ1 channel. Thus, when there is a stream of write requests, the write request on REQ1 channel starts using up the buffer that is reserved for REQ1 channel and then uses the other buffers reserved for the REQ0 channel by virtue of migrating the credits of the REQ0 channel to the REQ1 channel. If we have a request stream of read requests coming up on the REQ0 channel they can use all the buffers allocated to REQ0 channel except the one that has been reserved for the REQ1 channel.

In this case both the REQ0 and REQ1 channels can, in parallel, send memory requests to the receiver. In other words, a memory request can be sent on the REQ0 channel in the same cycle as a priority request is sent on the REQ1 channel using a credit provided for the REQ0 channel. Also, unlike the buffer control logic 508 shown in FIG. 5A there is no requirement for the use of a mux in the buffer control logic 528 and hence no mux-ing between the signals. This improves the area and frequency in a silicon implementation. However, the signals transmitted by the transmitter and that received by the receiver are not identical as the input to the receiver requires additional signals on the REQ1 channel to indicate whether the priority request on REQ1 channel is using a REQ0 credit or a REQ1 credit and the correct credit counters need to be updated.

With respect to the above tables 1-8, the worked example explained with respect to tables 1-7 is same for system 550. As explained with Table 7 above when the second write request is transmitted on the REQ1 channel, the transport node 514b will not be able to transmit the write request to the receiver because the receiver is holding on to the credit while the first write request is being processed. In other words, the transport node 514b needs the one credit allocated to REQ1 channel to be provided back to the REQ1 Tx2 credit counter before it can send anything else to the receiver.

In this situation the buffer control logic 528 enables the transfer of the credit from REQ0 channel to the REQ1 channel to ensure that the priority request keeps making progress. The buffer control logic 528 checks if the REQ0 Tx2 credit counter on the transport node 514b has credits available for sending the request on the REQ0 channel. In this case, the REQ0 Tx2 credit counter has 7 credits available for sending requests on REQ0. The buffer control logic 528 send a signal to the Transport node 514b to provide a credit from the REQ0 Tx2 credit counter to REQ1 channel thereby enabling the REQ1 channel to use the buffer allocated to the REQ0 channel. The transport node 514b decrements REQ0 Tx2 credit counter since it provides the credit for REQ0 channel to REQ1 channel to send the write request to the receiver. The write request is then transmitted to the receiver in the same clock cycle on the REQ1 channel using the credit provided from the REQ0 Tx2 credit counter as shown in Table 9. The receiver increments the REQ0 Rx credit counter to 1 indicating that the REQ1 channel used a buffer allocated to REQ0 channel by using the transferred credit. The receiver is provided with this information by the buffer control logic in a signal sent along with the write request transmitted on the REQ1 channel to the receiver. Also, the transport node 514b decrements the REQ1 Rx2 credit counter since it has passed the write request to the receiver, and the REQ1 request buffer is freed. So, the REQ1 Rx2 credit is passed back to REQ1 Tx1 credit counter:

TABLE 9

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 6 | 1 |
| REQ1 | 2 | 0 | 2 | 0 | 0 | 1 |

Table 8 and Table 9 are identical. However, in Table 9, the REQ1 channel is transmitting the write signal on the same REQ1 channel until it reaches the receiver using a credit transferred from the REQ0 channel whereas in Table 8, the REQ1 channel is transmitting the write signal on the REQ0 channel to the receiver using a credit available for the REQ0 channel.

In a second implementation of the system 550 the buffer control logic 528 works on a credit transfer mechanism by actually transferring a credit to REQ1 channel. The system 550 works in exactly in the same manner described above with respect to FIG. 5B when transmitting a read request and a first write request from the transmitter to the receiver,

When a second write request is transmitted on the REQ1 channel, buffer control logic checks if the REQ1 channel has a credit available, i.e. if the REQ1 Tx2 credit counter 516d has a credit available. If ‘No’ then the buffer control logic checks if the REQ0 channel has a credit available (at 532) i.e. if a credit is available for the REQ0 Tx2 credit counter 516c. If ‘Yes’, the buffer control logic 530 then request transfer of a credit to REQ1 channel from any other channel (here the REQ0 channel). If the REQ0 Tx2 credit counter 516c has available credits, and the REQ0 Tx2 credit counter 516c will transfer a credit associated with a buffer already allocated to the REQ0 channel to the REQ1 channel and increment the REQ1 Tx2 credit counter 516d in a first clock cycle. When a credit is passed to REQ1 Tx2 credit counter 516d then the buffer control logic 528 sends the write request on the REQ1 channel on path 58 utilizing a credit from REQ1 Tx2 credit counter 516d in a second clock cycle and stores the request in the buffer allocated to the REQ0 channel from where the credit was transferred to the REQ1 channel. The buffer control logic 528 also notifies the transmitter and receiver that the corresponding buffer associated with the REQ0 channel is used up by the REQ1 channel.

Thus, when there is a stream of write requests, the write request on REQ1 channel starts using up the buffer that is reserved for REQ1 channel and then uses the other buffers reserved for the REQ0 channel by virtue of migrating the credits of the REQ0 channel to the REQ1 channel. If we have a request stream of read requests coming up on the REQ0 channel they can use all the buffers allocated to REQ0 channel except the one that has been reserved for the REQ1 channel. This implementation also improves the area and frequency in a silicon implementation, unlike the buffer control logic 508 shown in FIG. 5A, as there is no requirement for the use of a mux in the buffer control logic 528 and hence no mux-ing between the signals. However, this implementation would consume an extra clock cycle as the write request is send to the receiver on a second clock cycle utilizing the transferred credit. Also, this implementation needs an additional bit of logic in the buffer control logic 528 to capture the fact that the REQ1 counter now contains a REQ0 credit as the receiver needs to be notified of the type of credit and hence buffer associated with which channel is used to transfer a request on REQ1 channel.

With respect to the above Tables 1-8, the worked example explained with respect to Tables 1-7 is also same for system 550 in this second implementation. As explained with Table 7 above when the second write request is transmitted on the REQ1 channel, the transport node 514b will not be able to transmit the write request to the receiver while the receiver is holding on to the credit while the first write request is being processed. In this case, the transport node 514b needs the one credit allocated to REQ1 channel to be provided back to the REQ1 Tx2 credit counter before it can send anything else to the receiver.

In such situation, in this second implementation, the buffer control logic 528 enables the receiver to transfer the credit from REQ0 channel to the REQ1 channel to ensure that the priority request keeps making progress. The buffer control logic 528 checks if the REQ0 Tx2 credit counter on the transport node 514b has credits available for sending the request on the REQ0 channel. In this case, the REQ0 Tx2 credit counter has 7 credits available for sending requests on REQ0. The buffer control logic 528 transfers a credit from the REQ0 Tx2 credit counter to the REQ1 Tx2 credit counter as shown in Table 10, in a clock cycle, thereby enabling the REQ1 channel to use the buffer allocated to the REQ0 channel:

TABLE 10

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 6 | 0 |
| REQ1 | 2 | 0 | 1 | 1 | 1 | 1 |

The write request is then transmitted to the receiver on the REQ1 channel using the new credit in the next clock cycle as shown in Table 11. The receiver increments the REQ0 Rx credit counter to 1 indicating that the REQ1 channel used a buffer allocated to REQ0 channel by using the transferred credit. The receiver is provided with this information in a signal along with the write request transmitted on the REQ1 channel to the receiver. Also, the transport node 514b decrements the REQ1 Rx2 credit counter since it has passed the write request to the receiver, and the REQ1 request buffer is freed. So, the REQ1 Rx2 credit is passed back to REQ1 Tx1 credit counter:

TABLE 11

| | modules | | | | | |
|---|---|---|---|---|---|---|
| | | Transport | | Transport | | |
| Credit | Transmitter | node 514a | | node 514b | | Receiver |
| counters | Tx | Rx1 | Tx1 | Rx2 | Tx2 | Rx |
| REQ0 | 2 | 0 | 2 | 0 | 6 | 1 |
| REQ1 | 2 | 0 | 2 | 0 | 0 | 1 |

In some examples, the system (400, 500 or 550) is bidirectional, that is each module could send and receive the data/request from each other. In such a case, the transmitter 502 would also act as a receiver and the receiver 504 would also act as a transmitter and the request channels will flow in both directions. The buffer control logic 508/528 may be located at the last transport node or at the receiver or as a standalone module somewhere in between the last transport node and the receiver.

FIG. 6 illustrates a method of controlling memory buffer reservation in accordance with the present invention. The method comprises, at step 602, providing a credit value to each request channel where at least one credit is provided to a first request channel. A plurality of memory requests can be transmitted on two or more request channels from a transmitter to a receiver. The receiver comprises a shared pool of buffers comprising a plurality of buffers. Each buffer has a credit. The total credits for all the buffers are split among the two or more request channels. Each channel could be allocated with one or more buffers. The credits are split based on the number of buffers pre-allocated to receive memory requests from the corresponding request channel. At least one request channel (the first request channel) among the two or more request channels is configured to transmit at least one priority request. To ensure that the priority request makes progress at all times at least one credit from the total credits is provided to the request channel transmitting the priority request.

At step 604 a memory request is transmitted on one of the channels by the transmitter. The different types of memory request could include but are not limited to a read request, a write request, a snoop request, a cache maintenance request etc. In one example, each request channel can transmit one type of memory request. In another example a request channel can transmit different types of memory request to the receiver.

At step 606, the method includes identifying if the memory request is a priority request. The priority request would be transmitted on a request channel configured to send the priority request (here on the first request channel). A priority request is a request that can cause a deadlock in the system if it does not make progress. In other words, the priority requests are requests that must eventually make progress. For example, in a system transmitting a plurality of memory requests such as a read request, a write request and a snoop request on two or more request channels, write requests can be considered as a priority request. This is because the completion of the read request might be blocked until the snoop request completes and completion of the snoop request might be blocked until the write request completes. Therefore, in this case it is vital that the write request can make forward progress to avoid a deadlock.

If yes, that is the memory request at step 606 is a priority request, then at step 608, the method includes checking if there is a credit available is available to the first request channel transmitting the priority request. Buffer control logic performs the step 608. As discussed earlier at least one credit is provided at step 602 to the request channel transmitting the priority request. If yes then at step 610, the transmitter transmits the priority request on the first channel utilizing the credit available to the first request channel.

If No, that is at step 608 it is identified that there is no credit available to the first request channel, then the method includes at step 612 checking if there is a credit available to another request channel sending the non-priority request. As discussed earlier at step 602, the credits are split across different request channels.

If yes, that is if there is a credit available to another request channel (second request channel), then the method at step 614 enables the first request channel to utilise a credit provided to a second request channel to transmit the priority request to the buffer allocated the second request channel when a credit provided to first request channel is unavailable. The step 614 can be implemented in different ways. In one embodiment, when a credit allocated to first request channel is unavailable and if there is a credit available to a second request channel (steps 608 and 612), then at step 614 the buffer control logic sends a request to the second request channel. On receiving a response from the second request channel, the buffer control logic commandeers the second request channel and using a credit provided to the second request channel sends the priority request on the second request channel instead of the first request channel. The priority request is therefore sent on the second request channel to a buffer allocated to the second request channel to ensure that the priority request makes progress. The buffer control logic sends the transmitter and receiver a signal that the particular buffer allocated to the second request channel is used by the priority request. In this embodiment since the second request channel is commandeered, the second request channel could not send any memory requests on second request channel until the priority request is transmitted.

In another embodiment, when a credit allocated to first request channel is unavailable and if there is a credit available to a second request channel (steps 608 and 612), the at step 614 the buffer control logic transfers a credit provided to the second request channel to the first request channel. This enables the first request channel to utilize a buffer allocated to the second request channel. The transmitter therefore sends the priority request on the first request channel using the transferred credit. In this case both the first and second request channels can, in parallel, send memory requests to the receiver. The transmitter or the buffer control logic will indicate to the receiver whether it is using a REQ0 credit or a REQ1 credit.

Now, if in step 606, the request is not a priority request, then the buffer control logic at step 612 checks if there is a credit available to the request channel on which the memory request is sent. If yes, at step 614, the buffer control logic utilizes the credit available to the request channel to send the memory request to a corresponding buffer in the receiver. If no, then the memory request has to wait until a buffer allocated to the request channel is freed and the corresponding request channel receives a credit.

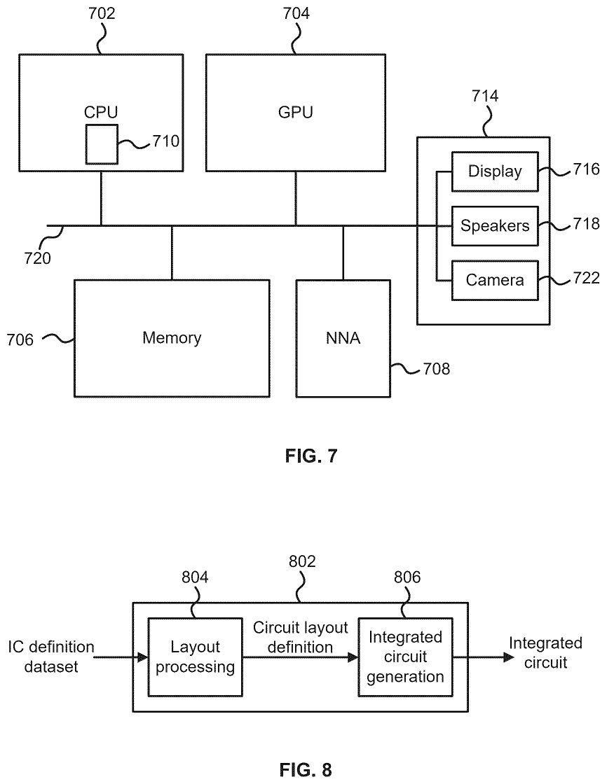

FIG. 7 shows a computer system in which processing systems described herein may be implemented. The computer system comprises a CPU 702, a GPU 704, a memory 706, a neural network accelerator (NNA) 708 and other devices 714, such as a display 716, speakers 718 and a camera 722. A buffer control logic 710 (corresponding to buffer control logic 408,508 or 528) is implemented on the CPU 702. In other examples, one or more of the depicted components may be omitted from the system, and/or the buffer control logic 710 may be implemented on the GPU 704 or within the NNA 708. The components of the computer system can communicate with each other via a communications bus 720.

The system of FIG. 4, 5A or 5B are shown as comprising a number of functional blocks. This is schematic only and is not intended to define a strict division between different logic elements of such entities. Each functional block may be provided in any suitable manner. It is to be understood that intermediate values described herein as being formed by a system need not be physically generated by the system at any point and may merely represent logical values which conveniently describe the processing performed by the system between its input and output.

The systems described herein may be embodied in hardware on an integrated circuit. The systems described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component”, “element”, “unit”, “block” and “logic” may be used herein to generally represent software, firmware, hardware, or any combination thereof. In the case of a software implementation, the module, functionality, component, element, unit, block or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be or comprise any kind of general purpose or dedicated processor, such as a CPU, GPU, NNA, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a system (400, 500 or 550) configured to perform any of the methods described herein, or to manufacture a system (400, 500 or 550) comprising any apparatus described herein. An integrated circuit definition dataset may be, for example, an integrated circuit description.

Therefore, there may be provided a method of manufacturing, at an integrated circuit manufacturing system, a system (400, 500 or 550) as described herein. Furthermore, there may be provided an integrated circuit definition dataset that, when processed in an integrated circuit manufacturing system, causes the method of manufacturing a system (400, 500 or 550) to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS® and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

An example of processing an integrated circuit definition dataset at an integrated circuit manufacturing system so as to configure the system to manufacture a system (400, 500 or 550) will now be described with respect to FIG. 8.

FIG. 8 shows an example of an integrated circuit (IC) manufacturing system 802 which is configured to manufacture a system (400, 500 or 550) as described in any of the examples herein. In particular, the IC manufacturing system 802 comprises a layout processing system 804 and an integrated circuit generation system 806. The IC manufacturing system 802 is configured to receive an IC definition dataset (e.g. defining a system (400, 500 or 550) as described in any of the examples herein), process the IC definition dataset, and generate an IC according to the IC definition dataset (e.g. which embodies a system as described in any of the examples herein). The processing of the IC definition dataset configures the IC manufacturing system 1002 to manufacture an integrated circuit embodying a system as described in any of the examples herein.

The layout processing system 1004 is configured to receive and process the IC definition dataset to determine a circuit layout. Methods of determining a circuit layout from an IC definition dataset are known in the art, and for example may involve synthesising RTL code to determine a gate level representation of a circuit to be generated, e.g. in terms of logical components (e.g. NAND, NOR, AND, OR MUX and FLIP-FLOP components). A circuit layout can be determined from the gate level representation of the circuit by determining positional information for the logical components. This may be done automatically or with user involvement in order to optimise the circuit layout. When the layout processing system 1004 has determined the circuit layout it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations and may be performed by different parties. For example, some of the stages of: (i) synthesising RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a system 400, 500 or 550 without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 8 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 8, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialised fashion or sharing functional blocks between elements of the devices, apparatus, modules and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein. In view of the foregoing description, it will be evident to a person skilled in the art that various modifications may be made within the scope of the invention.

What is claimed is:

1. A system for controlling memory buffer reservation, the system comprising:
a transmitter configured to transmit a plurality of memory requests on two or more request channels, the plurality of memory requests comprising at least one priority request transmitted on a first request channel;
a receiver comprising a plurality of buffers, each buffer having an associated credit, wherein each request channel is provided with a credit value based on the number of buffers allocated to receive memory requests from the corresponding request channel, where at least one credit is provided to the first request channel; and
buffer control logic configured to enable the first request channel to use a buffer allocated to a second request channel by utilizing a credit provided to the second request channel for transmitting the priority request to the receiver when a credit provided to first request channel is unavailable.

2. The system as claimed in claim 1, wherein the buffer control logic is further configured to check if there is a credit available to the first request channel, and if not, commandeer the second request channel and use a credit for the second request channel to send the priority request on the second request channel instead.

3. The system as claimed in claim 2, wherein the buffer control logic is further configured to, on sending the priority request on the second request channel, utilize the buffer allocated to the second request channel for storing the priority request transmitted on the second request channel.

4. The system as claimed in claim 1, wherein the buffer control logic is further configured to check if there is a credit available to the first request channel and, if not, transfer a credit provided to the second request channel to the first request channel and send the priority request on the first request channel using that credit.

5. The system as claimed in claim 4, wherein the buffer control logic is further configured to, on transferring a credit provided to the second request channel to the first request channel, utilize the buffer allocated to the second request channel for storing the request transmitted on the first request channel.

6. The system as claimed in claim 1, wherein the buffer control logic is configured to check if there is a credit available to the first request channel and, if so, send the priority request on the first request channel to a buffer allocated to the first request channel.

7. The system as claimed in claim 1, wherein the transmitter comprises a plurality of transmitter credit counters each associated with a request channel indicating the number of credits available to a particular request channel for transmitting the memory request.

8. The system as claimed in claim 1, wherein the receiver comprises a plurality of receiver credit counters each associated with a request channel indicating the number of buffers in the receivers used up by the particular request channel.

9. The system as claimed in claim 1, wherein the buffer control logic is a standalone module between the transmitter and the receiver or a module within the receiver.

10. The system as claimed in claim 1, wherein the system is bidirectional with the transmitter and the receiver capable of transmitting and receiving the memory request to each other.

11. The system as claimed in claim 1, wherein the system further comprises one or more transport nodes between the transmitter and receiver, optionally wherein each transport node comprises a transmitter credit counter, a receiver credit counter and at least on request buffer associated with each request channel.

12. The system as claimed in claim 11, wherein the buffer control logic is a module within the last transport node before the receiver.

13. A method of controlling memory buffer reservation, where a plurality of memory requests are transmitted from a transmitter to a plurality of buffers in a receiver on two or more request channels, the method comprising:
providing a credit value to each request channel among the two or more request channels based on the number of buffers allocated to receive memory requests from the corresponding request channel, wherein at least one credit is provided to a first request channel transmitting at least one priority request among the plurality of memory requests;
when transmitting a priority request on the first request channel:
identifying if there is a credit available to the first request channel; and
enabling the first request channel to utilise a credit provided to a second request channel to transmit the priority request to the receiver when a credit provided to first request channel is unavailable.

14. The method as claimed in claim 13, further comprising, when the credit allocated to the first request channel is unavailable, commandeering the second request channel and using a credit provided to the second request channel to send the priority request on the second request channel instead of the first request channel.

15. The method as claimed in claim 14, wherein commandeering the second request channel to send the priority request on the second request channel to the receiver enables the first request channel to use a buffer allocated to the second request channel.

16. The method as claimed in claim 13, further comprising, when the credit allocated to first request channel is unavailable, transferring a credit provided to the second request channel to the first request channel and sending the priority request on the first request channel using the transferred credit.

17. The method as claimed in claim 16, wherein transferring the credit provided to the second request channel to the first request channel enables the first request channel to use a buffer allocated to the second request channel.

18. A non-transitory computer readable storage medium having stored thereon computer executable code which causes the method as set forth in claim 13 to be performed when the code is run.

19. A non-transitory computer readable storage medium having stored thereon a computer readable dataset description of a system as set forth in claim 1 that, when processed in an integrated circuit manufacturing system, causes the integrated circuit manufacturing system to manufacture an integrated circuit embodying the system.

20. A CPU configured to perform the method as set forth in claim 13.
